(19) United States
(12) Patent Application Publication
(10) Pub. No.: US 2005/0055266 A1
(43) Pub. Date: Mar. 10, 2005

(54) Method and system for generating information about relationships between an enterprise and other parties and sharing such information among users in the enterprise

(75) Inventors: Thomas J. Foth, Trumbull, CT (US); Alton J. Volanth, Southbury, CT (US); G. Jonathan Wolfman, Southbury, CT (US); Howard M. Citron, South Salem, NY (US); Mark Dydzuhn, Monroe, CT (US)

Correspondence Address: Pitney Bowes Inc.;Intellectual Property &Technology Law Department, 35 Waterview Drive, P.O. Box 3000, Shelton, CT, 06484, US

(73) Assignee: Pitney Bowes Incorporated, Stamford, CT (US)

(21) Appl. No.: 10/656,789

(22) Filed: Sep. 5, 2003

(51) Int. Cl. G06F 17/60

(52) U.S. Cl. 705/10

(57) ABSTRACT

A system for automatically generating and distributing information relating to relationships between an enterprise and other parties. The system includes a computer for processing documents and a database system which includes a database of information relating to relationships between an enterprise and other parties; and a sever for controlling access to the database and for communicating with the computer. The computer is programmed to: monitor a document as it is processed by a user on the computer; identify a reference to a party in the document; and send information identifying the party to the server. The server is programmed to: receive the identifying information; access the database for information relating to a relationship between the enterprise and the party; and if a record relating to the party exists in the database, send the information relating to a relationship between the enterprise and the party to the computer. The information is generated, at least in part, based upon responses by system users to surveys generated by the server when another party is identified. The information sent relates to the value of the relationship to the enterprise and to the quality of the relationship. The information is also generated, at least in part, based upon survey responses by other enterprises. The system also can receive a request from the user for information from other information sources and the server is further programmed to formulate an inquiry to an information source in response to the request.

### BACKGROUND OF THE INVENTION

The present invention relates to methods and systems for managing relationships between an enterprise and other parties with which the enterprise deals. More particularly it relates to a method and system for gathering raw data, which can be both subjective opinion and objective data, about other parties with which an enterprise deals, summarizing and formatting the data gathered, and distributing the resulting information generated among users in the enterprise.

Customer Resource Management systems (hereinafter sometimes CRM systems) are known and will be familiar to anyone who deals regularly with a supplier having such a system. CRM systems allow users in a supplier organization to access information about a customer relationship. For example when a customer calls in an order a CRM system allows a representative to access information such as the customer's address, credit card number, credit rating, valued customer status, etc. CRM systems can also track a customer's buying habits so that marketing efforts can be targeted in a cost effective manner. While useful for their intended purpose, optimizing revenue production from a customer relationship, CRM systems are limited in that they are essentially repositories of objective information such as addresses, credit ratings and the like and typically do not contain information relating to subjective opinions which may be held by people in the supplier's organization. Further, CRM systems are typically passive in that they are responsive to requests for information, express or implied (e.g. a call from a customer to a representative is automatically treated as an implied request by the representative for information about that customer), and are not designed to actively “push” information to persons who may have a need for information about a relationship but not know where to seek the information, or who may be unaware of the importance of a relationship, or even of the existence of a relationship. Because in today's “just in time” economy suppliers can become integrated into an enterprise's structure to an extent which is uncommon for a customer, such capabilities, which CRM systems are believed to lack, are of particular importance in managing relationships between enterprises and their suppliers, strategic partners, professional service providers, and the like (hereinafter sometimes “parties” or “other parties”); where it may be important that anyone dealing with another party be aware of both the value or importance of the relationship and of the quality of the relationship. It is also believed to be important that the subjective opinions of at least some members of an enterprise be considered in formulating an overall, or enterprise wide, understanding of the value and quality of such relationships.

Thus it is an object of the present invention to provide a method and system which allows knowledge, including subjective opinion, about relationships between an enterprise and other parties to be broadly shared among users in the enterprise who may have dealings with the various other parties.

### BRIEF SUMMARY OF THE INVENTION

The above object is achieved and the disadvantages of the prior art are overcome in accordance with the present invention by a method, system and computer readable medium for providing instructions to implement the method in the system, to automatically generate and distribute information relating to relationships between an enterprise and other parties. In accordance with the present invention, a system is programmed to carry out a method including the steps of: a) monitoring a document as it is processed by a user; b) identifying a reference to a party in the document; c) accessing a database of information relating to relationships between an enterprise and other parties; and d) if a record relating to the party exists in the database, providing information relating to a relationship between the enterprise and the party to the user.

In accordance with one aspect of the present invention the information is generated, at least in part, based upon survey responses by system users.

In accordance with another aspect of the present invention the user is requested to respond to a survey when the information is provided and the user's response to the survey is used to update the information.

In accordance with another aspect of the present invention the information provided relates to a value of the relationship to the enterprise.

In accordance with another aspect of the present invention the information includes further information relating to a quality of the relationship

In accordance with another aspect of the present invention the information is generated, at least in part, based upon survey responses by other enterprises.

In accordance with another aspect of the present invention the system formulates an inquiry to an information source in response to a request from the user, where the scope of the inquiry, and to which information source, or sources, the inquiry is to be sent, are determined based on the nature and importance of the matter to which the inquiry relates.

Other objects and advantages of the present invention will be apparent to those skilled in the art from consideration of the detailed description set forth below and the attached drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a schematic block diagram of a system in accordance with the present invention.

FIG. 2 shows a flow diagram of the operation of user computers 16 shown in FIG. 1.

FIG. 3 shows a flow diagram of the operation of server 12 shown in FIG. 1.

FIG. 4 shows a pop-up display for input of user responses.

FIGS. 5A-5D show flow diagrams of the operation of sever 12 in response to various inputs by a user.

FIG. 6 shows a pop-up display for input of user responses relating to the quality of a relationship.

FIG. 7 shows a graphic display of a relationship.

FIG. 8 shows a pop-up display for input of user responses relating to the parameters of an inquiry about another party with which the enterprise has a relationship.

FIG. 9 shows a pop-up display for input of user responses relating to the value of a relationship.

### DETAILED DESCRIPTION OF PREFERRED EMBODIMENTS OF THE INVENTION

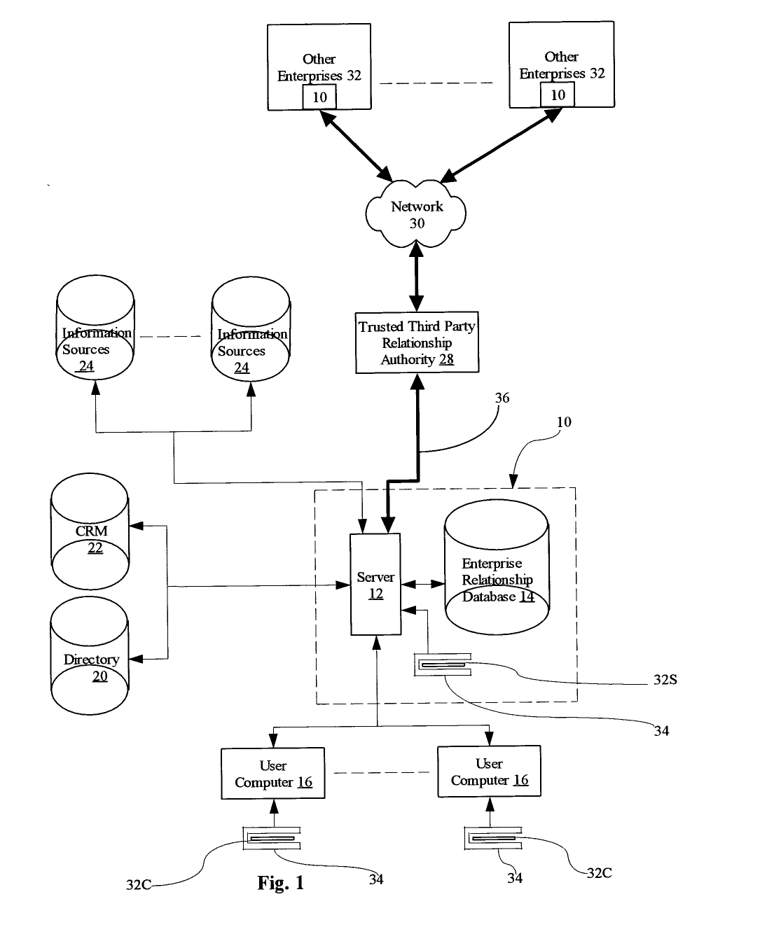

FIG. 1 shows a system for gathering data and generating and distributing information about relationships between an enterprise and various other parties such as suppliers, strategic partners, competitors, or, in general, any party with which the enterprise may have a relationship of sufficient importance that information, including subjective opinion, about the relationship should be broadly based and widely distributed among members of the enterprise. Database system 10 includes server 12 and enterprise relationship database 14. Server 12 communicates with user computers 16 to provide access to database 14 in a conventional manner. Database 14 stores individual and composite or overall ratings of relationships with other parties both in terms of value to the enterprise and in terms of the quality of the relationship.

Server 12 also communicates with personnel directory 20, CRM database 22, and information sources 24 to obtain additional information used to generate information about enterprise relationships, as will be described further below. Additionally server 12 communicates with other enterprises 32 through relationship authority 28 and network 30 to obtain other enterprises' 32 ratings of their relationships with other parties of interest, as will also be described further below. Preferably authority 28 is operated by a trusted third party who collects, abstracts and summarizes information about relationships from participating enterprises in a confidential and secure manner so that enterprises can share information about relationships with particular other parties without compromising competitive information. Preferably connection 36 and communications through network 30 between server 12 and authority 28 are secure connections such as an internet/https connections. Communication among server 12 and other devices shown in FIG. 1 is preferrably carried out in any convientient, conventional manner which need not be described further here for an understanding of the present invention.

Personnel database 20 stores information about various users including weights to be assigned to inputs by particular users and authorizations for access to particular system functions. CRM database 22 is a conventional customer resource management database and is accessed to identify other parties who are customers of the enterprise since this can affect other aspects of the relationship with that other party.

Information sources 24 are typically commercial sources such as those provided under the servicenames “Dun and Bradstreet” or “Lexus/Nexus” and are accessed by the system in accordance with predetermined enterprise standards when additional information about particular other parties is requested by a system user.

In the embodiment of FIG. 1 server 12 and computers 16 are programmed to carry out the method of the present invention by instructions provided by portable magnetic disks 32S, for server 12, and 32C, for computers 16, and disk drives 34. In other embodiments of the present invention any other convenient computer readable medium can be used to provide instructions to server 12 or computers 16. The term “computer-readable medium” as used herein refers to any medium that participates in providing instructions to server 12 or computers 16 for execution. Such a medium may take many forms, including but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

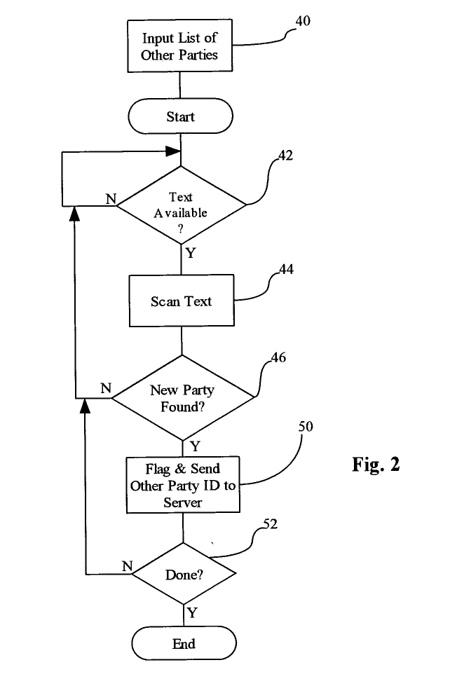

In a preferred embodiment of the present invention client software running on user computer 16 detects reference to another party in a document which is being processed (e.g. created, reviewed, or revised) on user computer 16. FIG. 2 shows a flow diagram of the operation of such client software.

At preliminary step 40 a list of other parties of interest is input. The list can be generated in any convenient manner and identifies those other parties which have relationships of at least minimal importance to the enterprise. Preferably other parties are identified by all common names or logos; (e.g. Pitney Bowes Inc., PBI, PB, Pitney) and can also be identified by the names of major divisions or subsidiaries.

Then, if the client software has been started, at step 42 computer 16 determines if text is available; i.e. if a document is being processed. If not the software loops through step 42, and otherwise, at step 44, scans the text. Preferably, as is common in the art, the text is scanned in the window screen buffer(s) (not shown) of computer 16. At step 46 computer 16 determines if another party, which has not previously been identified during the session, has been found. If not it returns to step 42. Otherwise at step 50 it sends the other party ID to server 12 and, at step 52 determines if the session is done, and, if not returns to step 42, and otherwise exits.

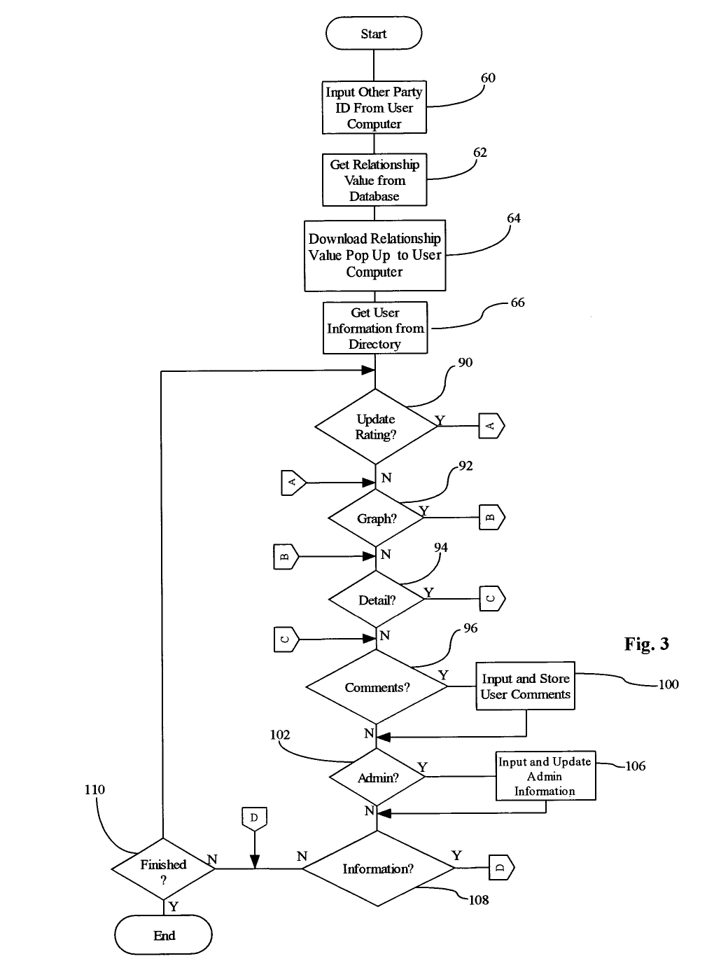

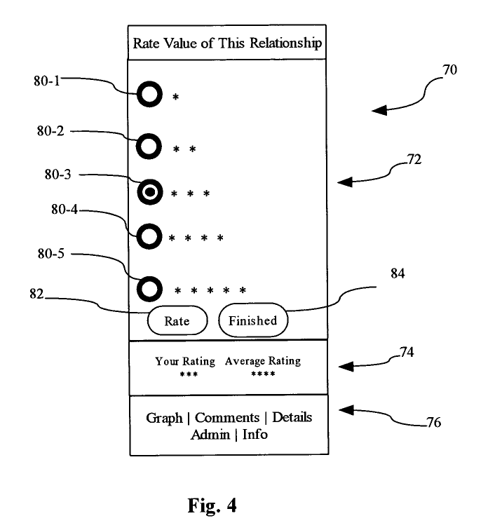

FIG. 3 shows diagram of the operation of server 12 in response to input of another party ID from computer 16. At step 60 server 12 inputs an other party's ID from the screen buffer(s) of computer 16. At step 62 it accesses database 14 to obtain a current rating for the value of the relationship. (By value herein is meant the perceived importance of the relationship to achieving goals of the enterprise.) At step 64 server 12 downloads a window screen of the type commonly referred to as a “pop-up” which is familiar to internet users, and which is shown in FIG. 4. At step 66 server 12 obtains user information which includes weights to be given to the user's inputs with respect to the particular relationship under consideration from personnel database 20. Preferably database 20 is maintained using the industry standard Lightweight Directory Access Protocol (LDAP) and stores information relating to system users such as weights to be given to a user's inputs with respect to a particular party, permitted access, account numbers etc.

Turning to FIG. 4, pop-up 70 includes fields 72, 74, and 76. Field 72 includes tabs 80-1 through 80-5, 82 and 84. A user can select a value rating for the relation ship with the other party by clicking on a corresponding one of tabs 80-1 through 80-5 and enter the rating by clicking on rate tab 82. The user can end the rating function by clicking on the finished tab 84. Field 74 displays the user's selected value rating and an average or overall rating. Field 76 displays additional tabs which the user can click on to select Graph, Comments, Details, Administrative, or Information capabilities as will be described further below.

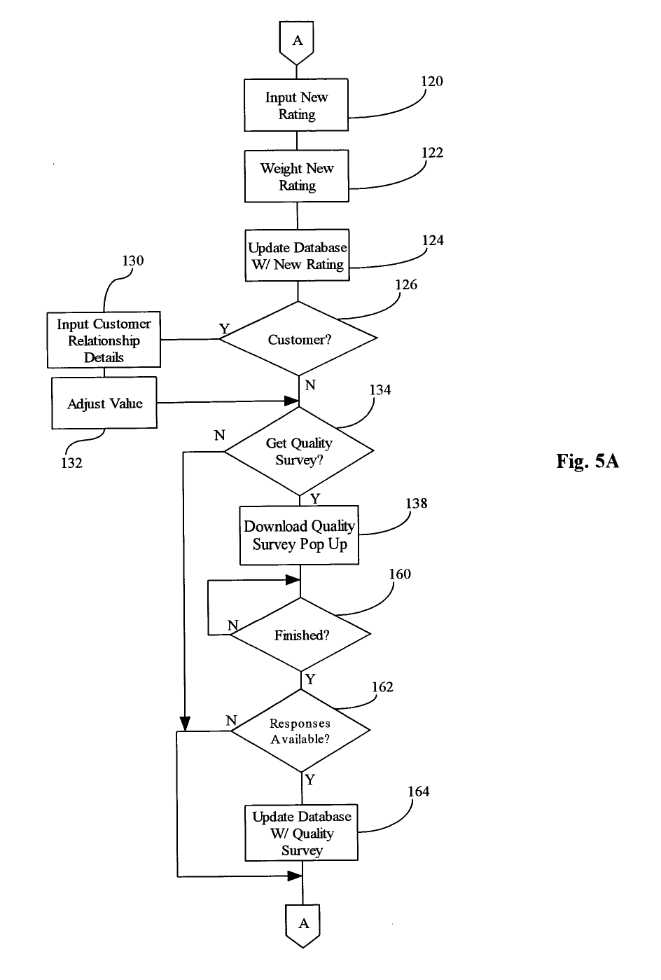

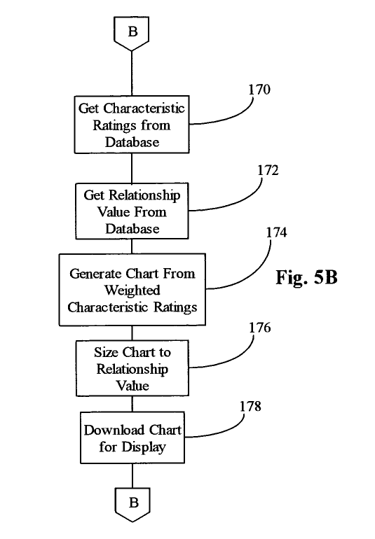

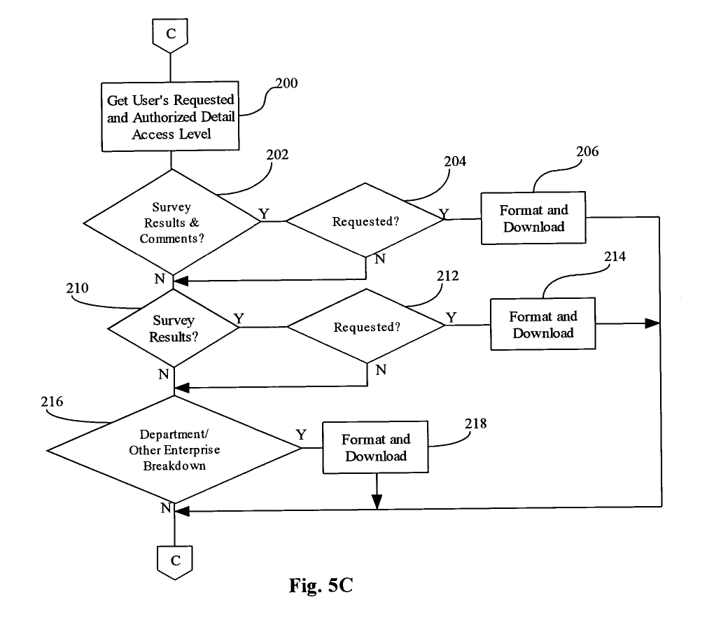

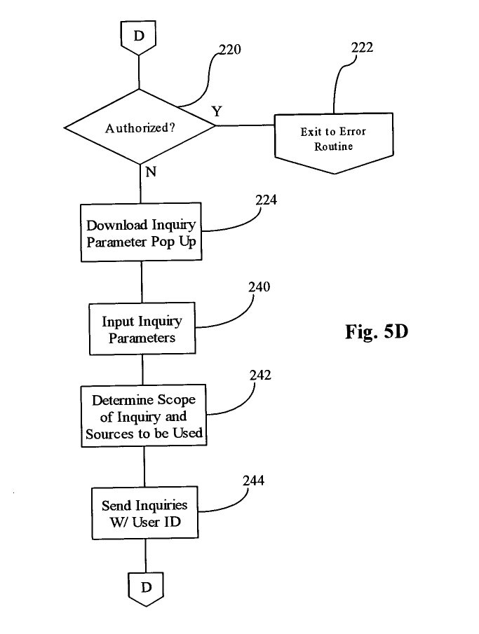

Returning to FIG. 3, at step 90 sever 12 determines if the user has entered a value rating and, if the weight to be given to the user's input is not zero, updates the value rating for the relationship under consideration, as will be described with respect to FIG. 5A below. Otherwise, or after updating the value rating, at step 92 server 12 determines if the user has requested a graphic view of the value and quality ratings for the relationship, as will be described with respect to FIG. 5B below. Otherwise, or after displaying the graph, at step 94 server 12 determines if the user has requested details of the value and quality ratings for the relationship, as will be described with respect to FIG. 5C below. Otherwise, or after returning details the value rating, at step 96 server 12 determines if the user has requested to input comments. If so, at step 100, server 12 inputs and stores the comments in database 14 with respect to the relationship in any convenient manner. Otherwise, or after storing the user's comments, at step 102 server 12 determines if the user has requested to update administrative information such as account numbers or passwords. If so, at step 106, server 12 inputs and stores the administrative information in any convenient manner. Otherwise, or after storing the administrative information, at step 108 server 12 determines if the user has requested information from other information sources 24, as will be described with respect to FIG. 5D below. Otherwise, or after returning the requested information, at step 110 server 12 determines if the user has finished, and if so ends the session for the relationship under consideration, and otherwise returns to step 90; thus allowing the user to modify ratings, requests for information, add comments, etc. based on responses received.

As shown in FIG. 5A, at step 120 sever 12 inputs the user's value rating, at step 122 applies the weights determined at step 66, and at step 124 updates database 14 with new overall ratings reflecting the user's weighted input; preferrably as a weighted sum of user inputs. These weights, for example, can vary with a user's position within the organization, experience with a particular party, or functional responsibilities. In other embodiments of the present invention value (and quality) ratings are maintained on a departmental or divisional basis as well as for the enterprise as a whole

At step 126 server 12 determines if the other party is a customer, and if so, at step 130 accesses CRM database 22 to obtain details of the customer relationship and then, at step 132, adjusts the value rating to reflect the other party's status as a customer. While the present invention contemplates that, for example, a relationship with a party who is both a supplier and a customer will, other things being equal, be more valuable to an enterprise than a relationship with a supplier who is not a customer; details of how value ratings should be adjusted to reflect an other party's customer status will vary for different enterprises and are preferably configurable based upon the system task.

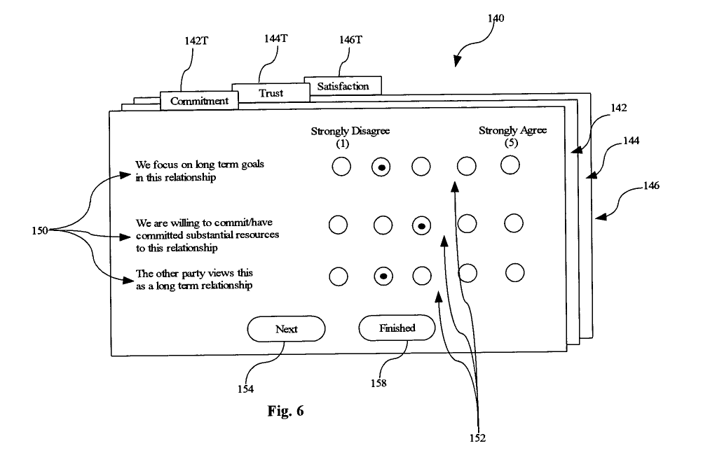

After any necessary adjustments to the value rating are made, at step 134 server 12 determines from information accessed at step 66 if the user is to be surveyed with regard to the quality of the relationship. If not it returns to step 92 in FIG. 3. Otherwise, at step 138, it downloads quality survey pop-up 140, shown in FIG. 6.

In FIG. 6, pop-up 140 includes layered windows 142, 144 and 146 for input of responses relating to characteristics which taken together define the quality of the relationship. These windows are identified by associated tabs 1442T, 144T and 146T, and can be opened by clicking on the associated tab. In the preferred embodiment shown the characteristics which determine the overall quality are commitment, trust and satisfaction. Preferably characteristics chosen to define the relationship quality are determined by the task, i.e. by the particular enterprise or division or department to be served, but will include at least system defined core characteristics such as trust and satisfaction so that a degree of comparability among ratings by different organizations is maintained.

Characteristics are rated as a function, preferably as a weighted sum, of a user's responses, through tabs 152, to statements pertaining to the characteristic. Statements 150 pertaining to commitment are illustrative and statements relating to other characteristics are not shown. In other embodiments of the present invention various users' responses regarding quality may be given different weights and the weights for a particular user may vary for different relationships, different characteristics or even with regard to particular statements. As with value ratings, these weights, for example, can vary with a user's position within the organization, experience with a particular party, or functional responsibilities. Preferably weights associated with a particular user are stored in personnel database 20 and accessed at step 66. As with characteristics, statements preferably are determined by the task but will include at least system defined core statements.

Each window in pop-up 140 includes next tab 154 which opens the next window when clicked. Each window also includes finished tab 158 which enters a user's responses when clicked.

Returning to FIG. 5A at step 160 sever 12 determines if the user has entered responses, and if not loops through step 160 until the user clicks on finished tab 158. Otherwise, at step 162 sever 12 determines if any responses have been entered, and if not returns to step 92 in FIG. 3. Otherwise, at step 164 sever 12 updates the quality ratings for the relationship under consideration to incorporate the user's entered, and preferably weighted, responses and returns to step 92 in FIG. 3.

If the user has requested a graph at step 92 in FIG. 3, then at step 170, shown in FIG. 5B, sever 12 accesses database 14 to get characteristic ratings for the relationship under consideration. Preferably the overall quality rating is computed as a weighted sum of the characteristic ratings. As described above the characteristic ratings preferably are weighted sums of the users' responses to statements pertaining to the various characteristics as illustrated in FIG. 6. For example, if the system defines quality, either in general or for a particular relationship, to consist of,
50% commitment
25% trust, and
25% satisfaction
   and the characteristic ratings (on a scale of 0-1) for the relationship under consideration are:
0.7 commitment
0.5 trust, and
0.8 satisfaction
   then the overall quality rating Q is:
   Q=(0.5)(0.7)+(0.25)(0.5)+(0.25)(0.8)=0.35+0.125+0.2=0.675=67.5%

At step 172 sever 12 gets an overall value rating, and then, at step 174 sever 12 generates a chart representative of the overall relationship quality, at step 176 sizes the chart proportionally to the relation ship value, and, at step 178 downloads the chart to computer 16 for display in any convenient manner.

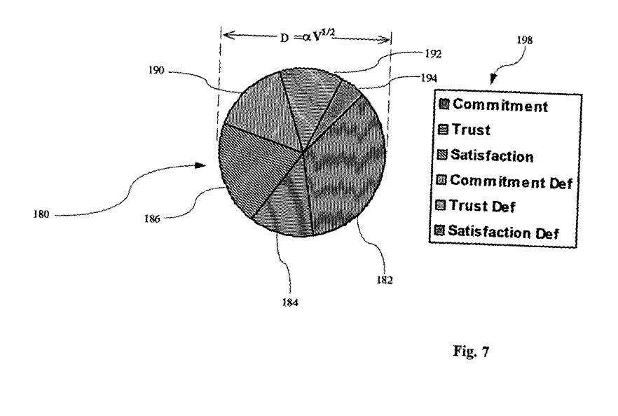

In a preferred embodiment of the present invention the graph takes the pie chart form shown in FIG. 7, where circle 180 represents 100% quality, segment 182 represents the contribution of commitment to the overall quality, segment 184 represents the contribution of trust to the overall quality and segment 186 represents the contribution of satisfaction to the overall quality. Segments 190, 192, and 194 represent the deficits in the corresponding characteristics which must be made up to achieve 100% quality. Diameter D is set proportionally with the square root of value rating V so that the area of circle 180 is proportional to value rating V. In other embodiments the value can be indicated by other characteristics such as intensity and the proportionality can be non-linear. Thus a user seeing the chart of FIG. 7 would have an immediate impression of the value of the relationship under consideration, the overall quality of that relationship, the contribution each characteristic makes to the overall quality, and the areas where improvement is most needed. Preferably label 198 is provided to identify the various segments.

If the user has requested further detail at step 96 in FIG. 3, then at step 200, shown in FIG. 5C, sever 12 inputs the user's requested level of detail, which is input in any convenient manner, and gets the user's authorized level of access, which preferably has been obtained from database 20 at step 66 in FIG. 3. Then at steps 202 and 204 server 12 determines if the user is authorized, and has requested, access to the highest level of detail, the individual survey results from, and comments by other users. If so, at step 206 server 12 accesses database 14, formats and downloads the requested details, and returns to step 96 in FIG. 3. Otherwise at steps 210 and 212 server 12 determines if the user is authorized, and has requested, access to survey results without comments. If so, at step 214 server 12 accesses database 14, formats and downloads the requested details, and returns to step 96 in FIG. 3. Otherwise, at step 216 server 12 determines if the user is authorized the default level of access; the overall value and/or quality ratings for selected other departments and divisions of the enterprise and for other enterprises. If so, at step 218 server 12 accesses database 14, formats and downloads the requested details, and returns to step 96 in FIG. 3. Preferably such selected overall ratings are displayed in graphic form substantially as shown in FIG. 7 and described above. (Selection of one or more particular overall ratings can be made by the user in any convenient manner.) Otherwise server 12 returns directly to step 96.

It should be noted that the level and/or type of detail available to various classes of users can be determined in any convenient manner for various tasks and is preferably a configurable feature of system 10.

If the user has requested to input comments at step 96 in FIG. 3 then at step 100 server 12 inputs the comments and stores them in database 14 linked to the relationship under consideration. Otherwise at step 102 server 12 determines if the user wishes to input administrative information such as passwords or account numbers, and, if so, at step 106 inputs and updates the user's administrative information, which is preferably stored in database 20. Functions such as the input and storage of comments and the updating of administrative information are well known in the art and further description of these functions is not believed necessary for an understanding of the present invention.

Then at step 108 server 12 determines if the user has requested information from other information sources. Typically such information will include objective information from commercial information sources such as those provided under the servicenames Dun and Bradstreet or Lexus/Nexus, but can also include information from noncommercial sources such as web pages. Since obtaining information has a cost (even information obtained from “free” web sites will have opportunity costs) enterprises typically will establish procedures for determining the nature and extent of information searches.

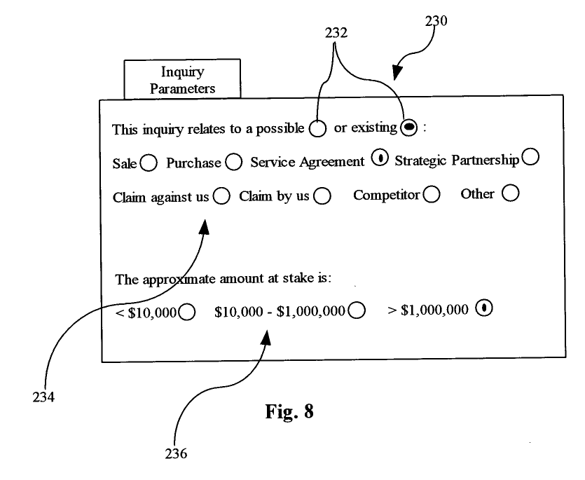

If he user has requested additional information, then at step 220 in FIG. 5D sever 12 determines if the user is authorized to obtain such additional information, and if not enters an error routine at step 222. Details of such error routine form no part of the present invention and will not be discussed further here. If the user is authorized, then at step 224 server 12 downloads a pop-up shown in FIG. 8 to obtain parameters for the inquiry request.

Pop-up 230 in FIG. 8 includes tabs 232 which identify whether the inquiry relates to possible or to an existing situation, tabs 234 which identify whether the inquiry relates to a sale, purchase, etc., and tabs 234 which identify the importance of the matter in terms of the dollar amount at stake.

Returning to FIG. 5D, at step 240 server 12 inputs the inquiry parameters and at step 242 determines the queries to be included in the inquiry and which of information sources 24 are to be used, based on the parameters input and the enterprise's predetermined standards. Such parameters and standards will be strongly task dependent and can readily be developed by a person skilled in the art for particular tasks; and, accordingly need not be described further here for an understanding of the invention.

Then at step 244 server 12 sends the inquiry to the selected sources together with user ID information including addresses, account numbers, etc., which were preferably obtained at step 66 in FIG. 3. Preferably selected sources 24 will handle the inquiry as though directly received from the user and will return the response to the user and bill the user's account. Note that the ID information may identify the user as an individual or can be pooled and only identify the user as a member of an organization. Server 12 then returns to step 110 in FIG. 3.

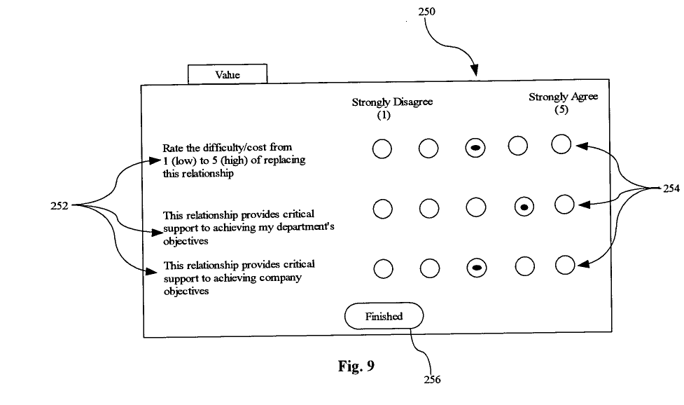

In other embodiments of the present invention pop-up 250, shown in FIG. 9 can be used to replace or supplement field 72 of pop-up 70 (shown in FIG. 4) to obtain a value rating. In one embodiment field 72 can be downloaded to users such as a director of strategic partnering or the like, whose responsibilities require broad understanding of relationships, while user's whose responsibilities are narrower in scope may receive pop-up 250. In other embodiments pop-up 250 can be used to test and validate user responses in field 72.

In FIG. 9 pop-up 250 includes statements 252 pertaining to the value of the relationship. Preferably statements 252 are determined by the task, i.e. by the particular enterprise or division or department to be served, but will include at least system defined core characteristics such as trust and satisfaction so that a degree of comparability among ratings by different organizations is maintained.

Value is rated as a function, preferably as a weighted sum, of a user's responses, through tabs 254, to statements 252. Statements 252 are illustrative. In other embodiments of the present invention various users' responses regarding quality may be given different weights and the weights for a particular user may vary for different relationships, different characteristics or even with regard to particular statements. As with value ratings in field 72, these weights, for example, can vary with a user's position within the organization, experience with a particular party, or functional responsibilities. Preferably weights associated with a particular user are stored in personnel database 20 and accessed at step 66. As with characteristics, statements 252 preferably will include at least system defined core statements. Pop-up 252 also includes finished tab 256 which enters a user's responses when clicked.

Returning to FIG. 1, sever 12 also communicates with relationship authority 28 through secure link 36. Authority 28 in turn communicates through network 30 with other systems 10 which are operated by other enterprises 32. Authority 28 accesses databases 14 in systems 10 operated by other enterprises 32 and abstracts value and quality ratings for various relationships other enterprises 32 have with various other parties, while removing critical or confidential information which enterprises 32 do not wish to share. In this manner an enterprise can incorporate the current experience of other enterprises which have relationships with a particular other party into its ratings of that other party. Preferably the extent and manner in which such other party ratings are incorporated is configurable and is based upon the task and or particular relationships to be rated. Preferably authority 28 is operated by a trusted third party who is relied upon to protect critical and confidential information so that information relating to the value and quality of relationships can be shared securely.

In another embodiment of the present invention databases 14 for all enterprises communicating with authority 28 can be maintained by authority 28. This avoids the need for authority 28 to communicate with every enterprise each time an enterprise initiates a session.

The embodiments described above and illustrated in the attached drawings have been given by way of example and illustration only. From the teachings of the present application those skilled in the art will readily recognize numerous other embodiments in accordance with the present invention. Accordingly, limitations on the present invention are to be found only in the claims set forth below.

1. A method for controlling a system for automatically generating and distributing information, comprising the steps of:
a) monitoring a document as it is processed by a user;
b) identifying a reference to a party in said document;
c) accessing a database of information relating to relationships between an enterprise and other parties; and
d) if a record relating to said party exists in said database, providing information relating to a relationship between said enterprise and said party to said user.

2. A method as described in claim 1 where said information is generated, at least in part, based upon survey responses by system users.

3. A method as described in claim 2 where said user is requested to respond to a survey when said information is provided and said user's response to said survey is used to update said information.

4. A method as described in claim 1 where said information provided relates to a value of said relationship to said enterprise.

5. A method as described in claim 4 where said information includes further information relating to a quality of said relationship.

6. A method as described in claim 5 where said further information includes a weighted sum of ratings for a plurality of characteristics of said relationship.

7. A method as described in claim 5 where said further information is provided in graphical form.

8. A method as described in claim 1 where said information is generated, at least in part, based upon survey responses by other enterprises.

9. A method as described in claim 1 where said other enterprise responses are collected and distributed by a third party in a confidential and secure manner to protect critical confidential information of said other enterprises.

10. A method as described in claim 1 including the further step of formulating an inquiry to an information source in response to a request from said user.

11. A method as described in claim 10 where the scope of said inquiry, and to which information source, or sources, said inquiry is to be sent, are determined based on the nature and importance of the matter to which said inquiry relates.

12. A system for automatically generating and distributing information, comprising:
a) a computer for processing documents;
b) a database system comprising:
b1) a database of information relating to relationships between an enterprise and other parties; and
b2) a sever for controlling access to said database and for communicating with said computer; where
c) said computer is programmed to:
c1) monitor a document as it is processed by a user on said computer;
c2) identify a reference to a party in said document; and
c3) send information identifying said party to said server; and where
d) said server is programmed to:
d1) receive said identifying information;
d2) access said database for information relating to a relationship between said enterprise and said party; and
d3) if a record relating to said party exists in said database, send said information relating to a relationship between said enterprise and said party to said computer.

13. A system as described in claim 12 where said information is generated, at least in part, based upon survey responses by system users.

14. A system as described in claim 13 where said server is further programmed to send a request to said computer for said user to respond to a survey when said information is provided and to update said information with new information reflecting said user's response to said survey.

15. A system as described in claim 12 where said information sent relates to a value of said relationship to said enterprise.

16. A system as described in claim 15 where said sent information includes further information relating to a quality of said relationship.

17. A system as described in claim 16 where said further information includes a weighted sum of ratings for a plurality of characteristics of said relationship.

18. A system as described in claim 16 where said further information is provided in graphical form.

19. A system as described in claim 12 where said information is generated, at least in part, based upon survey responses by other enterprises.

20. A system as described in claim 12 where said other enterprise responses are collected and distributed by a third party in a confidential and secure manner to protect critical confidential information of said other enterprises.

21. A system as described in claim 12 where said computer is further programmed to receive a request from said user for information from other information sources and said server is further programmed to formulate an inquiry to an information source in response to said request.

22. A system as described in claim 21 where the scope of said inquiry, and to which information source, or sources, said inquiry is to be sent, are determined based on the nature and importance of the matter to which said inquiry relates.

23. A computer programmed to process documents and further programmed to:
a) monitor a document as it is processed by a user on said computer;
b) identify a reference to a party in said document; and
c) send information identifying said party to a server; and
d) receive and display to said user information relating to a relationship between an enterprise and said party.

24. A computer as described in claim 23 where said further information is displayed in graphical form.

25. A sever in for controlling access to a database a system for automatically generating and distributing information to system users, said server being programmed to:
a) receive information identifying a party;
b) access said database for information relating to a relationship between an enterprise and said party; and
c) if a record relating to said party exists in said database, send said information relating to a relationship between said enterprise and said party to a computer for display to a system user.

26. A system as described in claim 25 where said information sent relates to a value of said relationship to said enterprise.

27. A system as described in claim 28 where said information sent includes further information relating to a quality of said relationship.

28. A system as described in claim 27 where said further information includes a weighted sum of ratings for a plurality of characteristics of said relationship.

29. A computer readable medium for providing instructions to a computer, said instructions controlling said computer to:
a) monitor a document as it is processed by a user on said computer;
b) identify a reference to a party in said document; and
c) send information identifying said party to a server; and
d) receive and display to said user information relating to a relationship between an enterprise and said party.

30. A computer readable medium for providing instructions to a server, said instructions controlling said server to:
a) receive information identifying a party;
b) access said database for information relating to a relationship between an enterprise and said party; and
c) if a record relating to said party exists in said database, send said information relating to a relationship between said enterprise and said party to a computer for display to a system user.
